(19) United States
(12) Patent Application Publication
(10) Pub. No.: US 2025/0216525 A1
(43) Pub. Date: Jul. 3, 2025

(54) MULTI-SENSOR FUSION DEVICE AND MULTI-SENSOR FUSION METHOD FOR PERFORMING EXTRINSIC CALIBRATION IN REAL TIME

(71) Applicant: KOOKMIN UNIVERSITY INDUSTRY ACADEMY COOPERATION FOUNDATION, Seoul (KR)

(72) Inventors: Yeong Min JANG, Seoul (KR); Utama Ida BAGUS KRISHNA YOGA, Seoul (KR)

(21) Appl. No.: 19/004,139

(22) Filed: Dec. 27, 2024

(30) Foreign Application Priority Data
Dec. 29, 2023 (KR) 10-2023-0196517
Dec. 17, 2024 (KR) 10-2024-0187832

(51) Int. Cl. G01S 7/497; G06T 7/80

(52) U.S. Cl. CPC G01S 7/497; G06T 7/80; G06T 2207/30252

(57) ABSTRACT

Proposed is a multi-sensor fusion device for performing extrinsic calibration in real time. The multi-sensor fusion device may include a camera unit including at least one camera and configured to produce image information of a surrounding environment by using the camera. The multi-sensor fusion device may also include a light detection and ranging (LiDAR) unit including at least one LiDAR and configured to produce a point cloud of the surrounding environment by using the LiDAR; a data combination unit configured to produce combined data in which the image information is combined with the point cloud. The multi-sensor fusion device may further include a data computation unit configured to derive an extrinsic calibration parameter by inputting the combined data into an extrinsic calibration model and perform extrinsic calibration of the camera and the LiDAR based on the derived extrinsic calibration parameter.

### CROSS-REFERENCE TO RELATED APPLICATION(S)

This application is based on and claims priorities under 35 U.S.C. 119 to Korean Patent Application No. 10-2023-0196517, filed on Dec. 29, 2023, and Korean Patent Application No. 10-2024-0187832, filed on Dec. 17, 2024, in the Korean Intellectual Property Office, the disclosure of each is hereby incorporated by reference in its entirety.

### BACKGROUND

### Technical Field

The present disclosure relates to a multi-sensor fusion system and a multi-sensor fusion method, wherein a multi-sensor fusion device, in which a light detection and ranging (LiDAR) is combined with a camera, performs extrinsic calibration in real time based on an artificial intelligence model.

### Description of Related Technology

Unmanned platforms, such as autonomous vehicles and unmanned aerial vehicles (UAVs), use various sensors to recognize surroundings, and based on the surroundings, plan autonomous traveling paths or control the movement of the unmanned platforms.

Therefore, for accurate and efficient autonomous traveling of unmanned platforms, it is important to integrate information collected from various sensors.

### SUMMARY

The present disclosure is invented to solve the problems described above. An aspect of the present disclosure is to provide a multi-sensor fusion device and a multi-sensor fusion method for performing extrinsic calibration in real time by using a targetless calibration method.

Another aspect of the present disclosure is to provide a multi-sensor fusion device and a multi-sensor fusion method for performing extrinsic calibration in real time, wherein an artificial intelligence model utilized for computing a calibration parameter is configured to have low complexity.

Another aspect of the present disclosure is to provide a multi-sensor fusion device and a multi-sensor fusion method for performing extrinsic calibration in real time, wherein a LiDAR-generated point cloud is converted into a one-dimensional vector during preprocessing of the artificial intelligence model.

Objects of the present disclosure are not limited to the above-mentioned object, and other objects and advantages of the present disclosure, which are not mentioned, will be understood through the following description, and will become apparent from embodiments of the present disclosure. It is also to be understood that the objects and advantages of the present disclosure may be realized by means and combinations thereof set forth in claims.

For the above aspects, a multi-sensor fusion device for performing extrinsic calibration in real time, according to an aspect of the present disclosure, includes: a camera unit including at least one camera and configured to produce image information of a surrounding environment by using the camera; a LiDAR unit including at least one LiDAR and configured to produce a point cloud of the surrounding environment by using the LiDAR; a data combination unit configured to produce combined data in which the image information is combined with the point cloud; and a data computation unit configured to derive an extrinsic calibration parameter by inputting the combined data into an extrinsic calibration model and perform extrinsic calibration of the camera and the LiDAR based on the derived extrinsic calibration parameter.

A multi-sensor fusion method for performing extrinsic calibration in real time, according to an aspect of the present disclosure, includes: producing image information of a surrounding environment by using a camera and a point cloud of the surrounding environment by using a LiDAR; producing combined data in which the image information is combined with the point cloud; deriving an extrinsic calibration parameter by inputting the combined data into an extrinsic calibration model; and performing extrinsic calibration of the camera and the LiDAR based on the derived extrinsic calibration parameter.

According to the present disclosure, extrinsic calibration is performed using a targetless calibration method, thereby enabling the estimation of a more accurate calibration parameter compared to a target-based calibration method in an environment requiring real-time calibration.

Furthermore, according to the present disclosure, the artificial intelligence model utilized for the calculation of the calibration parameter has low complexity, thereby reducing the computational cost of the extrinsic calibration. Therefore, the artificial intelligence model is usable in an environment requiring real-time calibration.

Also, according to the present disclosure, the point cloud produced by the LIDAR is converted into a one-dimensional vector and utilized, thereby reducing the computational cost of extrinsic calibration is reduced. Therefore, the point cloud is usable in an environment requiring real-time calibration.

### BRIEF DESCRIPTION OF THE DRAWINGS

The above and other aspects, features and advantages of the present disclosure will be more apparent from the following detailed description taken in conjunction with the accompanying drawings.

FIG. 1 illustrates the configuration of a multi-sensor fusion device according to an embodiment of the present disclosure.

FIG. 2 is a flow diagram illustrating a multi-sensor fusion method according to an embodiment of the present disclosure.

FIG. 3 is a detailed flowchart of the multi-sensor fusion method illustrated in FIG. 2.

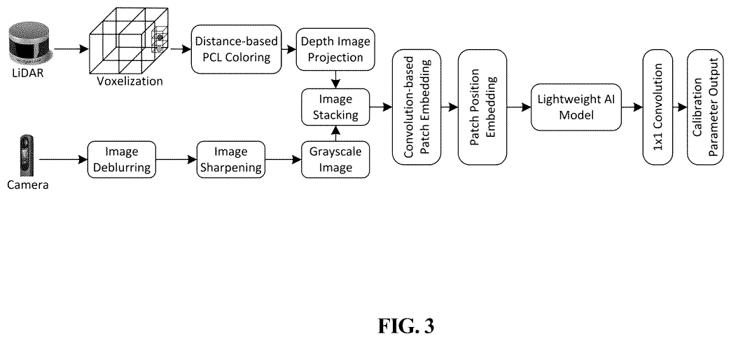

FIG. 4 illustrates an architecture block, which is the smallest unit constituting an encoder or a decoder of an extrinsic calibration model according to an embodiment of the present disclosure.

FIG. 5 illustrates the overall structure of an extrinsic calibration model according to an embodiment of the present disclosure.

### DETAILED DESCRIPTION

In a system where different sensor systems (e.g., a LiDAR and a camera) are integrated, an extrinsic calibration method is utilized. Typically, the extrinsic calibration method currently utilized is performed only once to set the initial values of sensors, and then, set calibration values are maintained on a moving unmanned platform. However, in the moving unmanned platform, the position of the sensors may change due to vehicle vibration, sensor bracket malfunction, road condition changes, etc.

In other words, the extrinsic calibration method used in the above system is not suitable for unmanned platforms that need to be calibrated in real time, due to the aforementioned factors. In addition, the existing extrinsic calibration method is mainly performed using a target-based calibration method.

For example, this method is a method by which a specific target (e.g., a checkerboard or an ArUco marker) is placed in front of LiDAR and camera sensors, and after the target is recognized by the LiDAR and camera sensors, a calibration parameter is calculated to estimate the relative coordinate relationship between the LiDAR and camera.

However, the target-based calibration can be effectively applied only in environments where the above-described sensor initial values are set only once and maintained thereafter. Furthermore, the target-based calibration is inaccurate or unavailable in environments that require real-time calibration, such as autonomous vehicles or UAVs.

In addition, the artificial intelligence model used to compute a calibration parameter in the existing extrinsic calibration method is configured to have high complexity, and thus is not suitable for environments that require real-time calibration.

In addition, the pre-processing of the artificial intelligence model in the existing extrinsic calibration method utilizes 2D or 3D vectors for LiDAR-generated point cloud, thereby slowing down the computation speed. Therefore, the existing extrinsic calibration method is not suitable for environments requiring real-time calibration.

Hereinafter, reference will be made in detail to exemplary embodiments of the present disclosure, examples of which are illustrated in the accompanying drawings and described below, and wherever possible, the same or similar elements will be denoted by the same reference numerals even though they are depicted in different drawings and a redundant description thereof will thus be omitted. In the following description of the embodiments, suffixes, such as “module”, and “part”, are provided or used interchangeably merely in consideration of ease in statement of the specification, and do not have meanings or functions distinguished from one another. In the following description of the embodiments of the present disclosure, a detailed description of known functions and configurations incorporated herein will be omitted when it may make the subject matter of the present disclosure rather unclear. Further, the accompanying drawings will be exemplarily given to describe the embodiments of the present disclosure, and should not be construed as being limited to the embodiments set forth herein, and it will be understood that the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

Firstly, to further describe the above-mentioned extrinsic calibration, the extrinsic calibration involves precisely defining the relative position and direction of each of multiple sensors (e.g., cameras, LiDARs, IMUs, etc.) constituting one device or system so that the multiple sensors can interact with each other.

Through this, data recorded in different coordinate systems measured by each sensor may be integrated, thereby enabling the aforementioned device or system to use accurate information.

More specifically, the extrinsic calibration may be used to derive an extrinsic calibration parameter necessary for converting data measured by one sensor into the coordinate system of another sensor.

For example, a camera may collect 3D information of a surrounding environment and project the 3D information onto an image plane as 2D image information, while a LiDAR may collect 3D information of the surrounding environment and produce a point cloud with 3D coordinates. Therefore, when an extrinsic calibration parameter, which reflects the relative position and direction of the camera and the LiDAR, is derived and applied using the extrinsic calibration, data having different coordinate systems may be integrated.

The extrinsic calibration parameter may include two main elements: a rotation matrix, which represents the relative rotational relationship between the sensors, and a translation vector, which represents the relative position of the sensors.

The extrinsic calibration may be implemented through various methods. For example, a target-based calibration method or a targetless calibration method is a typical extrinsic calibration method.

In the prior art, extrinsic calibration is mainly implemented based on the target-based calibration method, but this method is not suitable for unmanned platforms such as autonomous vehicles and unmanned aerial vehicles (UAVs), where the position of a sensor may change due to vehicle vibration, sensor bracket malfunction, road condition changes, etc.

Accordingly, a method for applying an artificial intelligence model to the targetless calibration method has been proposed to solve this problem. However, problems such as high computational cost due to the complex structure of the model and the inability to derive an extrinsic calibration parameter in real time have also been raised.

Accordingly, an embodiment of the present disclosure provides newly provide a multi-sensor fusion device and a multi-sensor fusion method for performing extrinsic calibration in real time, wherein the extrinsic calibration can be performed using a targetless calibration method while being conducted through a lightweight artificial intelligence model.

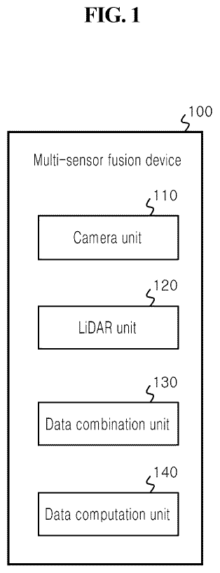

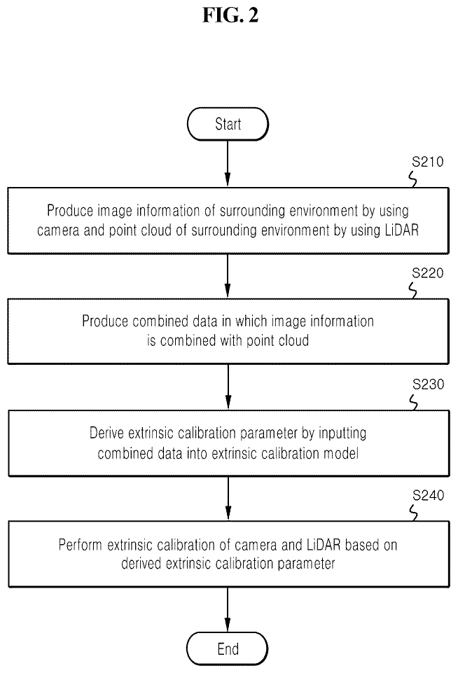

Hereinafter, a multi-sensor fusion device according to an embodiment of the present disclosure will be described with reference to FIGS. 1 and 2.

FIG. 1 illustrates the configuration of a multi-sensor fusion device according to an embodiment of the present disclosure. FIG. 2 is a flowchart illustrating a multi-sensor fusion method according to an embodiment of the present disclosure.

Referring to FIG. 1, a multi-sensor fusion device 100 according to an embodiment of the present disclosure includes a camera unit 110, a LIDAR unit 120, a data combination unit 130, and a data computation unit 140.

The camera unit 110 includes at least one camera, and produces image information of the surrounding environment by using the camera (see step S210).

For example, the image information may be information obtained by projecting collected 3D information of the surrounding environment onto an image plane as 2D image information.

The LiDAR unit 120 includes at least one LiDAR, and produces a point cloud of the surrounding environment by using the LiDAR (see step S210).

For example, the point cloud may be information obtained by reflecting 3D coordinates onto the collected 3D information of the surrounding environment.

The data combination unit 130 produces combined data in which the image information is combined with and the point cloud (see step S220).

Raw data of the point cloud produced by the LiDAR described above has at least millions of points.

If only key points are not extracted from the raw data of the point cloud through downsampling, the speed of computation may decrease during extrinsic calibration to be described later, thereby making real-time computation impossible.

Therefore, the data combination unit 130 processes the raw data of the point cloud through downsampling and performs preprocessing to match the dimensions of the processed raw data with the image information.

The data combination unit 130 performs downsampling based on voxelization of the raw data of the point cloud, and then converts the voxelized raw data of the point cloud into 2D image information.

For example, voxelization is the process of dividing a three-dimensional object or data into basic units called voxels, and allows the three-dimensional object or data to be simplified and represented.

Accordingly, the data combination unit 130 replaces multiple points in the raw data of the point cloud with a single representative point. For example, by setting a voxel size, points within the set size are compressed into one, resulting in the reduction of the data size of the point cloud.

Furthermore, since the above-described compression process removes unnecessary points and leaves only representative points, the feature of each point remains more distinct, thereby reducing the computational cost of subsequently utilizing the voxelized data.

Thus, the data combination unit 130 voxelizes the raw data of the point cloud to extract only the significant points.

Subsequently, the data combination unit 130 calculates the distance of each point in the voxelized raw data to an origin reference point in a three-dimensional space (x, y, z), and maps color information to each point based on the calculated distance.

The distance may be calculated based on Euclidean distance. Furthermore, the color mapped to each point may be represented by an RGB value.

When the data combination unit 130 maps, as described above, color information to each point, multiple points with similar distance values (e.g., points to which color information similarly is mapped) may be represented as point cloud segments that can represent the same object or area.

Then, the data combination unit 130 converts the voxelized raw voxel data, to which the color information is mapped, into 2D image information.

For example, the data combination unit 130 may convert, based on a projection, the 3D coordinates of each voxel constituting the voxelized raw data to which the color information is mapped into coordinates of a 2D plane, and apply the attributes (e.g., mapped color, transparency, etc.) of each voxel to the converted coordinates to convert the raw data into 2D image information.

This may have the effect of reducing the size of the data due to 2D while using points with features, thereby reducing the computation speed.

Then, the data combination unit 130 produces combined data by combining the 2D image information and the image information based on image stacking.

For example, image stacking is the process of combining multiple images to produce a single final image, and may be used to extract common parts from the multiple images used for the combination or combine additional information that may represent features.

In other words, the data combination unit 130 may finally combine 3D information collected by the LiDAR and 2D information collected by the camera through image stacking to produce the combined data.

The data computation unit 140 inputs the combined data into an extrinsic calibration model to derive an extrinsic calibration parameter (see step S230), and performs extrinsic calibration of the camera and the LiDAR based on the derived extrinsic calibration parameter (see step S240).

The extrinsic calibration model is a model that is trained to receive data in which image information and a point cloud are combined and derive an extrinsic calibration parameter.

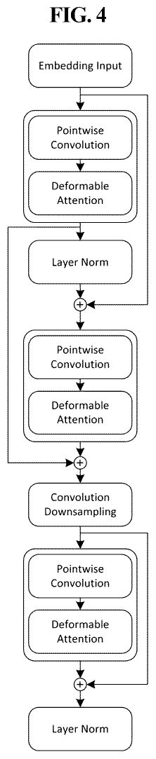

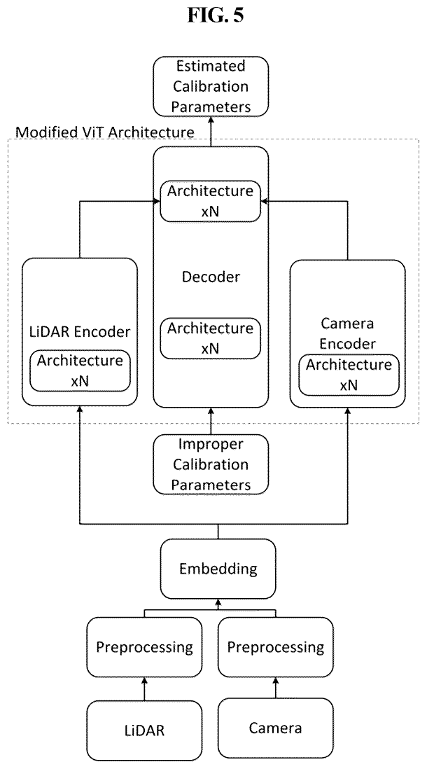

In this regard, FIG. 4 illustrates an architecture block which is the smallest unit constituting an encoder or a decoder of an extrinsic calibration model according to an embodiment of the present disclosure. FIG. 5 illustrates the overall structure of an extrinsic calibration model according to an embodiment of the present disclosure.

Hereinafter, the structure of the extrinsic calibration model described above will be described with reference to FIGS. 4 and 5.

The extrinsic calibration model applies patch embedding and position embedding based on convolution to combined data to produce an embedding image.

Patch embedding is the process of dividing image data into small pieces called patches and converting each patch into a high-dimensional vector.

Each of the patches may be formed in a square shape, and is converted to a one-dimensional vector.

The extrinsic calibration model converts the patches into high-dimensional vectors based on a linear transformation. The dimension that are converted may be determined differently depending on the size of patches.

Furthermore, the extrinsic calibration model produces multiple patch images by using a convolutional layer in which the patch size matches the kernel size.

Then, to preserve the original position of the patches in the combined data, position embedding, which adds position information of the patches, may be used.

Thus, the extrinsic calibration model may add, to each patch, position information based on a color mapped to 2D image information.

Furthermore, the extrinsic calibration model is a model having a structure in which two encoders and one decoder based on a vision transformer are combined.

More specifically, the two encoders in the extrinsic calibration model includes a LIDAR encoder and a camera encoder.

The LiDAR encoder extracts only a 1-channel image of 2D image information from the embedding image, and the camera encoder extracts a 1-channel image of image information from the embedding image.

In other words, each encoder may process embedding data produced by a LIDAR and a camera.

The LiDAR encoder may include a sequence of eight architecture blocks, and the camera encoder may include six architecture blocks.

In addition, the decoder receives an extrinsic calibration parameter produced with a value equal to or greater than a predetermined error during the training of the extrinsic calibration model, converts the received extrinsic calibration parameter into an extrinsic calibration parameter less than the predetermined error, and outputs the converted extrinsic calibration parameter.

For example, the decoder may include a sequence of two architecture blocks.

Then, the extrinsic calibration model derives an estimated extrinsic calibration parameter, based on a 1×1 convolution of the images, which are extracted by the two encoders, and the extrinsic calibration parameter, which is output by the decoder and less than the predetermined error.

More specifically, the images extracted by the two encoders may be transmitted as input values for a second architecture block of the decoder, and an input value, in which the images extracted by the two encoders is combined with the extrinsic calibration parameter by a first decoder and less than the predetermined error, may be converted into a result value of the extrinsic calibration parameter through computation based on a 1×1 convolution while passing through five blocks organized in series in the second architecture of the decoder.

For example, the 1×1 convolution may refer to a convolution performed on a one-dimensional vector by randomly varying the stride size.

As described above, in the multi-sensor fusion device and the multi-sensor fusion method for performing extrinsic calibration in real time according to an embodiment of the present disclosure, an extrinsic calibration model is configured to combine 2D image information, in which the main features of each point of a point cloud raw data collected by the LiDAR, with image information produced by the camera, and to calculate an extrinsic calibration parameter based on the combined data and a vision transformer structure.

As a result, the extrinsic calibration model has a lightweight structure compared to the existing vision transformer and CNN models, making it possible to perform extrinsic calibration in real time.

In addition, extrinsic calibration is performed using a targetless calibration method, and thus may be carried out even in environments where parameter values change in real time, such as in unmanned platforms.

In the specification (particularly, in the claims) of the present disclosure, use of the term “above” and similar referential terms may refer to both the singular and the plural. In addition, when a range is stated in the present disclosure, the statement includes the invention to which individual values within the range are applied (unless there is a statement to the contrary), and is the same as a statement of the individual values constituting the range in the detailed description of the invention.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

What is claimed is:

1. A multi-sensor fusion device for performing extrinsic calibration in real time, the multi-sensor fusion device comprising:
a camera unit comprising at least one camera and configured to produce image information of a surrounding environment by using the camera;
a light detection and ranging (LiDAR) unit comprising at least one LiDAR and configured to produce a point cloud of the surrounding environment by using the LiDAR;
a data combination unit configured to produce combined data in which the image information is combined with the point cloud; and
a data computation unit configured to derive an extrinsic calibration parameter by inputting the combined data into an extrinsic calibration model and perform extrinsic calibration of the camera and the LiDAR based on the derived extrinsic calibration parameter.

2. The multi-sensor fusion device of claim 1, wherein the data combination unit is configured to convert the point cloud into 2D image information, based on voxelization.

3. The multi-sensor fusion device of claim 2, wherein the data combination unit is configured to produce the combined data by combining the 2D image information and the image information, based on image stacking.

4. The multi-sensor fusion device of claim 3, wherein the extrinsic calibration model is configured to produce an embedding image by applying patch embedding and position embedding based on convolution to the combined data.

5. The multi-sensor fusion device of claim 4, wherein the extrinsic calibration model has a structure in which two encoders and one decoder based on a vision transformer are combined.

6. The multi-sensor fusion device of claim 5, wherein the two encoders comprise a LIDAR encoder and a camera encoder,
wherein the LiDAR encoder is configured to extract only a 1-channel image of the 2D image information from the embedding image, and
wherein the camera encoder is configured to extract only a 1-channel image of the image information from the embedding image.

7. The multi-sensor fusion device of claim 6, wherein the decoder is configured to:
receive an extrinsic calibration parameter produced with a value equal to or greater than a predetermined error during training of the extrinsic calibration model;
convert the received extrinsic calibration parameter into an extrinsic calibration parameter less than the predetermined error; and
output the extrinsic calibration parameter less than the predetermined error.

8. The multi-sensor fusion device of claim 7, wherein the extrinsic calibration model is configured to derive the estimated extrinsic calibration parameter, based on a 1×1 convolution of the images, which are extracted by the two encoders, and the extrinsic calibration parameter, which is output by the decoder and less than the predetermined error.

9. The multi-sensor fusion device of claim 1, wherein the extrinsic calibration model is configured to be trained to receive data in which image information and a point cloud are combined, and derive an extrinsic calibration parameter.

10. A multi-sensor fusion method for performing extrinsic calibration in real time, the multi-sensor fusion method comprising:
producing image information of a surrounding environment by using a camera and producing a point cloud of the surrounding environment by using a light detection and ranging (LiDAR);
producing combined data in which the image information is combined with the point cloud;
deriving an extrinsic calibration parameter by inputting the combined data into an extrinsic calibration model; and
performing extrinsic calibration of the camera and the LiDAR based on the derived extrinsic calibration parameter.

11. The multi-sensor fusion method of claim 10, wherein the producing of the combined data comprises converting the point cloud into 2D image information, based on voxelization.

12. The multi-sensor fusion method of claim 11, wherein the producing of the combined data further comprises producing the combined data by combining the 2D image information and the image information, based on image stacking.

13. The multi-sensor fusion method of claim 12, wherein the extrinsic calibration model is configured to produce an embedding image by applying patch embedding and position embedding based on convolution to the combined data.

14. The multi-sensor fusion method of claim 13, wherein the extrinsic calibration model has a structure in which two encoders and one decoder based on a vision transformer are combined.

15. The multi-sensor fusion method of claim 14, wherein the two encoders comprise a LIDAR encoder and a camera encoder,
wherein the LiDAR encoder is configured to extract only a 1-channel image of the 2D image information from the embedding image, and
wherein the camera encoder is configured to extract only a 1-channel image of the image information from the embedding image.

16. The multi-sensor fusion method of claim 15, wherein the decoder is configured to:
receive an extrinsic calibration parameter produced with a value equal to or greater than a predetermined error during training of the extrinsic calibration model;
convert the received extrinsic calibration parameter into an extrinsic calibration parameter less than the predetermined error; and
output the extrinsic calibration parameter less than the predetermined error.

17. The multi-sensor fusion method of claim 16, wherein the extrinsic calibration model is configured to derive the estimated extrinsic calibration parameter, based on a 1×1 convolution of the images, which are extracted by the two encoders, and the extrinsic calibration parameter, which is output by the decoder and less than the predetermined error.

18. The multi-sensor fusion method of claim 10, wherein the extrinsic calibration model is configured to be trained to receive data in which image information and a point cloud are combined, and derive an extrinsic calibration parameter.
